(19) United States
(12) Patent Application Publication
(10) Pub. No.: US 2026/0052018 A1
(43) Pub. Date: Feb. 19, 2026

(54) METHODS AND APPARATUSES FOR A COMMUNICATION SYSTEM

(71) Applicant: Robert Bosch GmbH, Stuttgart (DE)

(72) Inventors: Florian Rudolf Beenen, Grafenau (DE); Oleg Schell, Krautheim (DE); Sebastian Paul, Stuttgart (DE)

(21) Appl. No.: 19/292,037

(22) Filed: Aug. 6, 2025

(30) Foreign Application Priority Data
Aug. 15, 2024 (DE) 10 2024 207 780.1

(51) Int. Cl. H04L 9/32

(52) U.S. Cl. CPC H04L 9/3215; H04L 9/3263

(57) ABSTRACT

A method for a device, in particular terminal device, for a subnet of a wireless communication system. The method includes: sending a request to transmit first information, in particular to a unit, in particular a control unit for the subnet, wherein the first information makes it possible to verify an authenticity of at least one unit associated with the subnet; and receiving a response including at least the first information.

### CROSS REFERENCE

The present application claims the benefit under 35 U.S.C. § 119 of Germany Patent Application No. DE 10 2024 207 780.1 filed on Aug. 15, 2024, which is expressly incorporated herein by reference in its entirety.

### FIELD

The present invention relates to methods for a communication system.

The present invention further relates to apparatuses for a communication system.

### SUMMARY

Some examples of the present invention relate to a method for a device, for example terminal device (e.g., UE (user equipment)), for a subnet of a wireless communication system, comprising: sending a request to transmit first information, for example to a unit, for example a control unit for the subnet, wherein the first information makes it possible to verify an authenticity of at least one unit associated with the subnet; receiving a response comprising at least the first information. In some examples, this makes it possible to perform a, for example mutual, authentication or to initiate steps for a mutual authentication, for example between the terminal device and the unit for the subnet. For example, the first information contains or represents a public key of the unit, for example control unit for the subnet. For example, the public key of the unit is part of a cryptographic key pair of the unit, wherein the key pair comprises, for example, a private key in addition to the public key.

For example, the method described above can be used to authenticate the device or multiple devices in the subnet or subnetwork even if (e.g., currently) there is no connection to an operator network. For example, certificates issued in advance can be used for authentication.

In some examples of the present invention, the wireless communication system is, for example, a cellular mobile radio system, for example according to or based on the 4G standard, or according to or based on the 5G standard, or according to or based on the 6G standard, or according to or based on at least one other existing and/or planned standard.

Accordingly, in some examples of the present invention, the terminal device is compliant or compatible with or based on the 4G standard or the 5G standard or the 6G standard or at least one other existing and/or planned standard.

In some examples of the present invention, the subnet can also be considered or referred to as a subnetwork.

In some examples of the present invention, the response additionally comprises configuration information associated with the subnet, whereby the device, e.g., terminal device, can be efficiently informed, for example, about at least one of the following elements: a) purpose of the subnet, or b) aspects of a trust relationship, or c) aspects of a certification authority.

For example, the method comprises: sending second information to the unit, for example for verifying an authenticity of the unit; receiving third information from the unit, wherein, for example, the third information has been generated by the unit based at least in part on the second information (for example using the private key of the unit); and, optionally, verifying the third information based at least on the first information. For example, the second information is so-called challenge information of a challenge-response process, and the third information is, for example, corresponding response information that the unit has formed, e.g., using its private key, based at least on the challenge information. For example, the device, e.g., terminal device, can verify the response information based on its knowledge of the challenge information using the public key (e.g., contained in or represented by the first information) of the unit.

For example, the response that the device, e.g., terminal device, receives comprises a certificate associated with the unit, which certificate, for example, comprises a public key associated with the unit.

In some examples of the present invention, the method comprises: sending a request regarding options for authentication by the unit, to the unit; receiving a response comprising information regarding the options for authentication by the unit. In some examples, the response comprising the information regarding the options for authentication by the unit, comprises, for example only, the information regarding the options for authentication by the unit, or the response represents the information regarding the options for authentication by the unit.

In some examples of the present invention, the method comprises: sending fourth information, which makes it possible to verify an authenticity of the terminal device, to the unit; receiving fifth information, for example from the unit, for example for verifying an authenticity of the device. For example, the fourth information may comprise a certificate or a signature of a further unit of the communication system, for example a network unit for the communication system, for example for a core network, or information signed by such a network unit. For example, the fifth information is or comprises challenge information for a challenge-response process between the unit for the subnet and the device, e.g., terminal device.

In some examples of the present invention, the method comprises: generating sixth information based at least on the fifth information and a private key associated with the device, e.g., terminal device; sending the sixth information to the unit. For example, the sixth information is response information for the challenge-response process mentioned as an example in the previous paragraph.

In some examples of the present invention, the method comprises: using the subnet, for example based on configuration information or the configuration information for the subnet; and, optionally, exchanging information by means of the subnet.

In some examples of the present invention, the method comprises: requesting key information, for example characterizing a public key, for encrypting information to be sent to at least one other unit (e.g., the unit for the subnet and/or the network unit); receiving the key information. For example, the device may request and/or receive the key information from the network unit, for example via a direct data connection (e.g., via a Uu interface) to the network unit, or via the control unit for the subnet.

In some examples of the present invention, the method comprises: generating an asymmetric key pair; optionally, encrypting an identification associated with a public key of the asymmetric key pair; sending a request to sign the public key, for example together with the optionally encrypted identification, to at least one other unit, for example a network unit, for example of a core network; receiving a response, e.g., in the form of a certificate, to the request; and, optionally, using at least parts of the response, e.g., the certificate, for authentication, for example for the subnet, for example to the control unit for the subnet, for example if a network unit, for example of the core network, is not reachable, for example at least temporarily.

Further examples of the present invention relate to an apparatus for performing the method according to the disclosure.

Further examples of the present invention relate to a device, for example terminal device, for a subnet of a wireless communication system comprising at least one apparatus according to the disclosure. In some examples, the apparatus or a functionality associated with the apparatus is integrated into the device, e.g., terminal device. In other examples, the apparatus or a functionality associated with the apparatus is not integrated into the device, e.g., terminal device, but is, e.g., connected via a data connection to the device.

Further examples of the present invention relate to a method for a unit, for example a control unit for a subnet of a wireless communication system, comprising: receiving a request to transmit first information, for example from a device, for example terminal device, for the subnet, wherein the first information makes it possible to verify an authenticity of at least one unit associated with the subnet; sending a response comprising at least the first information, for example to the device, wherein, for example, the response additionally comprises configuration information associated with the subnet, wherein, for example, the response comprises a certificate associated with the unit, which certificate, for example, comprises a public key associated with the unit.

In some examples of the present invention, the method comprises: receiving second information, for example from the device, for example for verifying an authenticity of the unit; forming third information based at least in part on the second information; sending the third information, for example to the device.

In some examples of the present invention, the method comprises: receiving a request regarding options for authentication by the unit; sending a response comprising information regarding the options for authentication by the unit, to the device.

In some examples of the present invention, the method comprises: receiving fourth information, which makes it possible to verify an authenticity of the terminal device; verifying the authenticity of the terminal device based at least on the fourth information; optionally, performing a challenge-response process with respect to the device; optionally, allowing the device onto the subnet, for example based on a result of the challenge-response process.

Some examples of the present invention relate to an apparatus for performing the method according to the disclosure.

Some examples of the present invention relate to a unit, for example a control unit for a subnet of a wireless communication system, for example subnetwork controller, comprising at least one apparatus according to the disclosure. In some examples, the apparatus or a functionality associated with the apparatus is integrated into the unit, e.g., the subnetwork controller. In other examples, the apparatus or a functionality associated with the apparatus is not integrated into the unit, e.g., the subnetwork controller, but is, e.g., connected via a data connection to the unit, e.g., the subnetwork controller.

Further examples of the present invention relate to a method for a network unit, for example of a core network of a wireless communication system, comprising: receiving a request from a device (e.g., terminal device), for example directly from the device or via at least one further unit, for example a control unit for a subnet of the wireless communication system, to request key information, for example characterizing a public key, for encrypting information to be sent by means of the device, for example to at least one other unit; sending the key information to the device, for example directly to the device or via a or the control unit for a or the subnet of the wireless communication system. In some examples, this makes it possible to provide the device, e.g., terminal device, with the key information so that it can authenticate itself to the unit, e.g., the subnetwork controller, e.g., at a later point in time, e.g., when the network unit is temporarily unavailable or a data connection between the device and the network unit temporarily does not exist.

In some examples of the present invention, it is provided for the method to comprise: receiving a request, from the device, to sign a public key of the device, for example together with an optionally encrypted identification of the public key; signing at least part of information associated with the request, for example contained in the request, thereby obtaining signed information; sending the signed information to the device, for example directly to the device or via a or the control unit for a or the subnet of the wireless communication system.

Further examples of the present invention relate to an apparatus for performing the method according to the disclosure.

Further examples of the present invention relate to a network unit, for example for a core network of a wireless communication system, comprising at least one apparatus according to the disclosure.

Further examples of the present invention relate to a communication system, for example wireless communication system, comprising at least one of the following elements: a) apparatus according to the disclosure, or b) device, for example terminal device, according to the disclosure, or c) apparatus according to the disclosure, or d) unit according to the disclosure, or e) apparatus according to the disclosure, or f) network unit according to the disclosure.

Some examples of the present invention relate to a computer-readable storage medium comprising commands that, when executed by a computer, cause said computer to perform the method according to the disclosure.

Some examples of the present invention relate to a computer program comprising commands that, when the program is executed by a computer, cause said computer to perform the method according to the disclosure.

Some examples of the present invention relate to a data carrier signal that transmits and/or characterizes the computer program according to the disclosure.

Some examples of the present invention relate to a use of the method according to the disclosure, and/or of the apparatus according to the disclosure, and/or of the device, for example terminal device, according to the disclosure, and/or of the unit, for example control unit, for a subnet of a wireless communication system according to the disclosure, and/or of the network unit, for example for a core network of a wireless communication system, according to the disclosure, and/or of the communication system according to the disclosure, and/or of the computer-readable storage medium according to the disclosure, and/or of the computer program according to the disclosure, and/or of the data carrier signal according to the disclosure for at least one of the following elements: a) making authentication associated with the subnet possible, for example without a connection to a network of an operator (e.g., operator network), for example core network, or b) mutually authenticating apparatuses associated with the subnet, or c) increasing flexibility, for example for operation of the subnet, or d) making independence from an operator network or reachability of the operator network possible, or c) avoiding unauthorized access to the subnet.

Further features, possible applications and advantages can be found in the following description of examples, which are shown in the figures. All features described or shown form the subject matter of the disclosure individually or in any combination, regardless of their combination, or their wording or representation in the description or in the figures.

### BRIEF DESCRIPTION OF THE DRAWINGS

FIG. 1 schematically shows a simplified flow chart, according to an example embodiment of the present invention.

FIG. 2 schematically shows a simplified block diagram, according to an example embodiment of the present invention.

FIG. 3 schematically shows a simplified block diagram, according to an example embodiment of the present invention.

FIG. 4 schematically shows a simplified flow chart, according to an example embodiment of the present invention.

FIG. 5 schematically shows a simplified flow chart, according to an example embodiment of the present invention.

FIG. 6 schematically shows a simplified flow chart, according to an example embodiment of the present invention.

FIG. 7 schematically shows a simplified flow chart, according to an example embodiment of the present invention.

FIG. 8 schematically shows a simplified flow chart, according to an example embodiment of the present invention.

FIG. 9 schematically shows a simplified flow chart, according to an example embodiment of the present invention.

FIG. 10 schematically shows a simplified flow chart, according to an example embodiment of the present invention.

FIG. 11 schematically shows a simplified flow chart, according to an example embodiment of the present invention.

FIG. 12 schematically shows a simplified flow chart, according to an example embodiment of the present invention.

FIG. 13 schematically shows a simplified flow chart, according to an example embodiment of the present invention.

FIG. 14 schematically shows a simplified flow chart, according to an example embodiment of the present invention.

FIG. 15 schematically shows a simplified flow chart, according to an example embodiment of the present invention.

FIG. 16 schematically shows a simplified block diagram, according to an example embodiment of the present invention.

FIG. 17 schematically shows a simplified signaling diagram, according to an example embodiment of the present invention.

FIG. 18 schematically shows a simplified signaling diagram, according to an example embodiment of the present invention.

FIG. 19 schematically shows a simplified signaling diagram, according to an example embodiment of the present invention.

FIG. 20 schematically shows a simplified block diagram, according to an example embodiment of the present invention.

### DETAILED DESCRIPTION OF EXAMPLE EMBODIMENTS

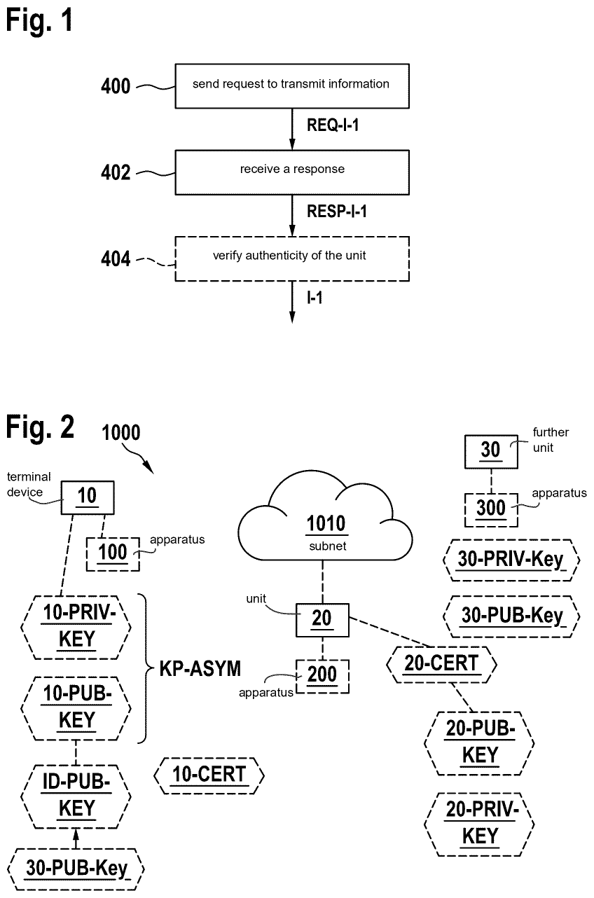

Some examples, see, for example, FIG. 1, 2, relate to a method for a device, for example a terminal device 10 (e.g., UE (user equipment)), for a subnet 1010 of a wireless communication system 1000, comprising: sending 400 (FIG. 1) a request REQ-I-1 to transmit first information I-1, for example to a unit 20, for example a control device for the subnet 1010, wherein the first information I-1 makes it possible to verify an authenticity of at least one unit (e.g., unit 20) associated with the subnet 1010; receiving 402 a response RESP-I-1 comprising at least the first information I-1. In some examples, this makes it possible to perform a, for example mutual, authentication or to initiate steps for a mutual authentication, for example between the terminal device 10 and the unit 20 for the subnet 1010. For example, the first information I-1 contains or represents a public key 20-PUB-KEY of the unit 20, for example control unit for the subnet 1010. For example, the public key 20-PUB-KEY of the unit 20 is part of a cryptographic key pair (not shown) of the unit 20, wherein the key pair comprises, for example, a private key 20-PRIV-KEY in addition to the public key.

The optional block 404 according to FIG. 1 symbolizes an optional use of the first information I-1, for example for verifying an authenticity of the unit 20.

In some examples, FIG. 2, the wireless communication system 1000 is, for example, a cellular mobile radio system, for example according to or based on the 4G standard, or according to or based on the 5G standard, or according to or based on the 6G standard, or according to or based on at least one other existing and/or planned standard.

Accordingly, in some examples, FIG. 2, the terminal device 10 is compliant or compatible with or based on the 4G standard or the 5G standard or the 6G standard or at least one other existing and/or planned standard.

In some examples, FIG. 1, 3, the response RESP-I-1 additionally comprises configuration information INF-CFG-SN associated with the subnet 1010, whereby the device, e.g., terminal device, 10 can be efficiently informed, for example, about at least one of the following elements: a) purpose of the subnet 1010, or b) aspects of a trust relationship, or c) aspects of a certification authority.

For example, FIG. 4, the method comprises: sending 410 second information I-2 to the unit 20, for example for verifying an authenticity of the unit 20; receiving 412 third information I-3 from the unit 20, wherein, for example, the third information I-3 has been generated by the unit 20 based at least in part on the second information I-2 (for example using the private key 20-PRIV-KEY (FIG. 2) of the unit 20); and, optionally, verifying 414 the third information I-3 based at least on the first information I-1.

For example, the second information I-2 is so-called challenge information of a challenge-response process, and the third information I-3 is, for example, corresponding response information that the unit 20 has formed, e.g., using its private key 20-PRIV-KEY, based at least on the challenge information I-2. For example, the device, e.g., terminal device, 10 can verify the response information I-3 based on its knowledge of the challenge information I-2 using the public key 20-PUB-KEY (e.g., contained in or represented by the first information I-1) of the unit 20.

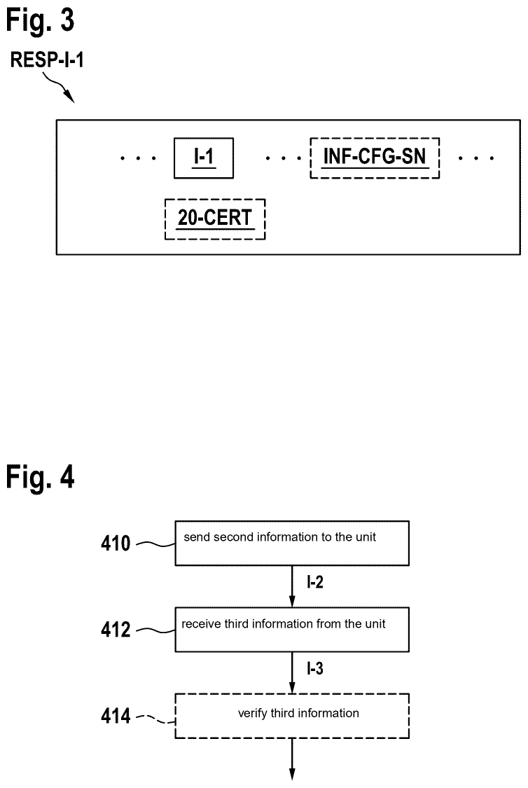

For example, FIG. 1, 2, the response RESP-I-1 that the device, e.g., terminal device 10, receives comprises a certificate 20-CERT (FIG. 3) associated with the unit 20, which certificate, for example, comprises a or the public key 20-PUB-KEY associated with the unit 20.

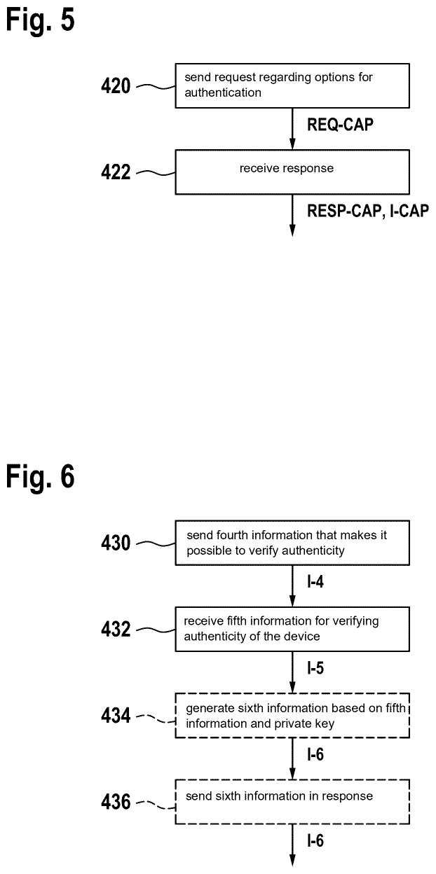

In some examples, FIG. 5, the method comprises: sending 420 a request REQ-CAP regarding options for authentication by the unit 20, to the unit 20; receiving 422 a response RESP-CAP comprising information I-CAP regarding the options for authentication by the unit 20. In some examples, the response RESP CAP comprising the information I-CAP regarding the options for authentication by the unit 20, comprises, for example only, the information regarding the options for authentication by the unit, or the response RESP-CAP represents the information I-CAP regarding the options for authentication by the unit 20.

In some examples, FIG. 6, the method comprises: sending 430 fourth information I-4, which makes it possible to verify an authenticity of the terminal device 10, to the unit 20; receiving 432 fifth information I-5, for example from the unit 20, for example for verifying an authenticity of the device 10. For example, the fourth information I-4 may comprise a certificate or a signature of a further unit 30 (FIG. 2) of the communication system 1000, for example a network unit 30 for the communication system, for example for a core network, or information signed by such a network unit 30. For example, the fifth information I-5 is or comprises challenge information for a challenge-response process between the unit 20 for the subnet and the device, e.g., terminal device 10.

In some examples, FIG. 6, the method comprises: generating 434 sixth information I-6 based at least on the fifth information I-5 and a private key 10-PRIV-KEY (FIG. 2) associated with the device, e.g., terminal device, 10; sending 436 the sixth information I-6 to the unit 20. For example, the sixth information I-6 is response information for the challenge-response process mentioned as an example in the previous paragraph, based on the fifth information I-5 as the challenge information.

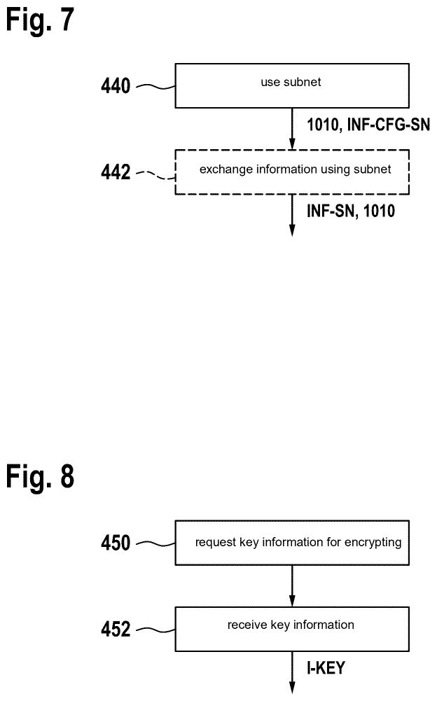

In some examples, FIG. 7, the method comprises: using 440 the subnet 1010 (FIG. 2), for example based on configuration information INF-CFG-SN (see also FIG. 3) or the configuration information for the subnet 1010; and, optionally, exchanging 442 information INF-SN by means of the subnet 1010.

In some examples, FIG. 8, the method comprises: requesting 450 key information, for example characterizing a public key 20-PUB-KEY, for encrypting information to be sent to at least one other unit (e.g., the unit 20 for the subnet and/or the network unit 30); receiving 452 the key information I-KEY. For example, the device 10 may request and/or receive the key information I-KEY from the network unit 30, for example via a direct data connection (e.g., via a Uu interface) to the network unit 30, or via the control unit 20 for the subnet 1010.

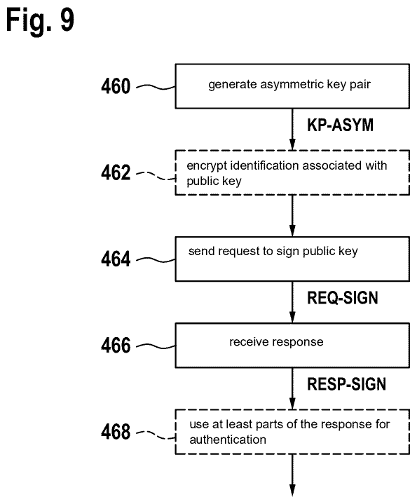

In some examples, FIG. 9, the method comprises: generating 460 an asymmetric key pair KP-ASYM; optionally, encrypting 462 an identification ID-PUB-KEY associated with a public key 10-PUB-KEY of the asymmetric key pair KP-ASYM, e.g., by means of a public key 30-PUB-KEY (FIG. 2) of a core network; sending 464 a request REQ-SIGN, for example certificate signing request, to sign the public key 10-PUB-KEY, for example together with the optionally encrypted identification, to at least one other unit 30, for example a network unit, for example of a core network; receiving 466 a response RESP-SIGN, for example in the form of a certificate, to the request REQ-SIGN, for example certificate signing request; and, optionally, using 468 at least parts of the response RESP-SIGN, e.g., the certificate, for authentication, for example for the subnet 1010, for example to the control unit 20 for the subnet 1010, for example if a network unit 30, for example of the core network, is not reachable, for example at least temporarily. In some examples, the response RESP-SIGN may also comprise a certificate 10-CERT for the device 10.

In some examples, the public key 10-PUB-KEY of the device is thus not used for the optional encryption 462 of the identification ID-PUB-KEY, but rather, for example, in a separate step, a public key 30-PUB-KEY of the core network is requested, which can be used for the optional encryption 462 of the identification ID-PUB-KEY. This makes it possible, for example, for the operator network to establish an association between an obfuscated identification (e.g., encrypted by means of the public key of the core network) and permanent identification of the device 10. The core network 30 (FIG. 2) also has a private key 30-PRIV-KEY associated with the public key 30-PUB-KEY of the core network.

Further examples, FIG. 2, relate to an apparatus 100 for performing the method according to the disclosure, for example comprising at least one aspect according to at least one of FIG. 1, 3, 4, 5, 6, 7, 8, 9.

Further examples, FIG. 2, relate to a device 10, for example terminal device, for a subnet 1010 of a wireless communication system 1000 comprising at least one apparatus 100 according to the disclosure. In some examples, the apparatus 100 or a functionality associated with the apparatus 100 is integrated into the device, e.g., terminal device, 10. In other examples, the apparatus 100 or a functionality associated with the apparatus is not integrated into the device, e.g., terminal device, 10, but is, e.g., connected via a data connection to the device.

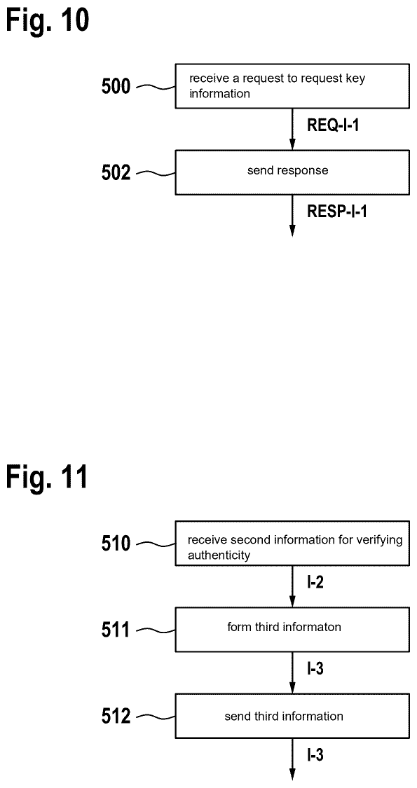

Further examples, FIG. 10, relate to a method for a unit 20, for example a control unit for a subnet 1010 of a wireless communication system 1000, comprising: receiving 500 a request REQ-I-1 to transmit first information I-1, for example from a device, for example terminal device, 10 for the subnet 1010, wherein the first information I1 makes it possible to verify an authenticity of at least one unit associated with the subnet; sending 502 a response RESP-I-1 comprising at least the first information I-1, for example to the device 10, wherein, for example, the response RESP-I-1 additionally comprises configuration information INF-CFG-SN associated with the subnet 1010, wherein, for example, the response RESP-I-1 comprises a certificate 20-CERT associated with the unit 20, which certificate, for example, comprises a public key 20-PUB-KEY associated with the unit 20.

In some examples, FIG. 11, the method comprises: receiving 510 second information I-2, for example from the device 10, for example for verifying an authenticity of the unit 20; forming 511 third information I-3 based at least in part on the second information I-2; sending 512 the third information I-3, for example to the device 10.

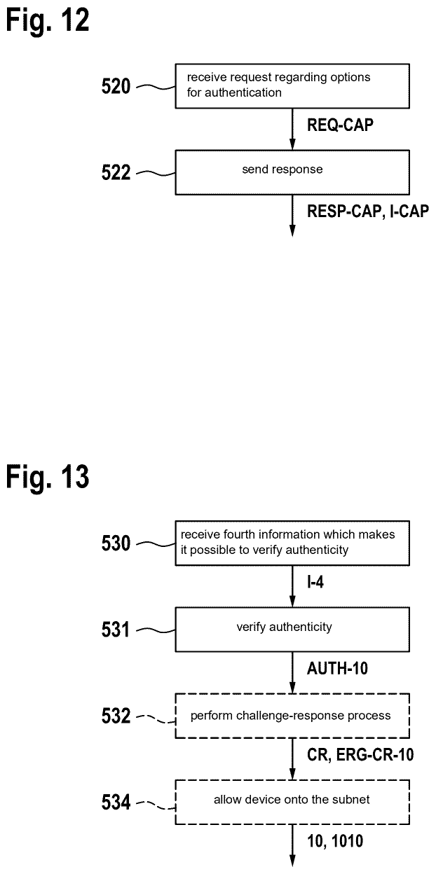

In some examples, FIG. 12, the method comprises: receiving 520 a request REQ-CAP regarding options for authentication by the unit 20; sending 522 a response RESP-CAP comprising information I-CAP regarding the options for authentication by the unit 20, to the device 10.

In some examples, FIG. 13, the method comprises: receiving 530 fourth information I-4, which makes it possible to verify an authenticity of the terminal device 10; verifying 531 the authenticity AUTH-10 of the terminal device 10 based at least on the fourth information I-4; optionally, performing 532 a challenge-response process CR with respect to the device 10; optionally, allowing 534 the device 10 onto the subnet 1010, for example based on a result ER-CR-10 of the challenge-response process CR.

Some examples, FIG. 2, relate to an apparatus 200 for performing the method according to the disclosure herein.

Some examples, FIG. 2, relate to a unit 20, for example a control unit for a subnet 1010 of a wireless communication system 1000, for example subnetwork controller 20, comprising at least one apparatus 200 according to the disclosure. In some examples, the apparatus 200 or a functionality associated with the apparatus 200 is integrated into the unit, e.g., the subnetwork controller, 20. In other examples, the apparatus 200 or a functionality associated with the apparatus 200 is not integrated into the unit, e.g., the subnetwork controller, 20, but is, e.g., connected via a data connection to the subnetwork controller 20.

Further examples, FIG. 2, 14, relate to a method for a network unit 30, for example of a core network of a wireless communication system, comprising: receiving 600 a request REQ-I-KEY from a device (e.g., terminal device) 10, for example directly from the device 10 or via at least one further unit 20, for example a control unit for a subnet 1010 of the wireless communication system 1000, to request key information I-KEY, for example characterizing a public key (e.g., of the core network), for encrypting information to be sent by means of the device 10, for example to at least one other unit 20, 30; sending 602 the key information I-KEY to the device, for example directly to the device 10 or via a or the control unit 20 for a or the subnet of the wireless communication system. In some examples, this makes it possible to exchange key material, e.g., in order to obfuscate, for example encrypt, the identification of the device 10.

In order for the device, e.g., terminal device, 10 to be able to authenticate itself to the unit 20, e.g., the subnetwork controller, e.g., at a later point in time, e.g., when the network unit 30 is temporarily unavailable or a data connection between the device 10 and the network unit 30 temporarily does not exist, a certificate can be provided in some examples.

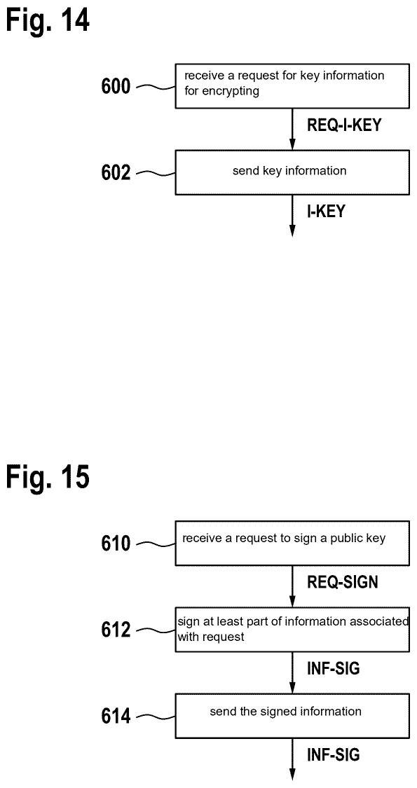

In some examples, FIG. 15, it is provided for the method to comprise: receiving 610 a request REQ-SIGN, from the device 10, to sign a public key 10-PUB-KEY of the device 10, for example together with an optionally encrypted identification ID-PUB-KEY of the public key 10-PUB-KEY (the optionally encrypted identification ID-PUB-KEY of the public key 10-PUB-KEY can be obtained e.g., by means of the public key 30-PUB-KEY of the core network, see FIG. 14); signing 612 at least part of information (e.g., public key 10-PUB-KEY) associated with the request and, for example, contained in the request REQ-SIGN, thereby obtaining signed information INF-SIG (e.g., a certificate); sending 614 the signed information INF-SIG, e.g., in the form of a certificate, to the device 10, for example directly to the device 10 or via a or the control unit 20 for a or the subnet 1010 of the wireless communication system 1000.

Further examples, FIG. 2, relate to an apparatus 300 for performing the method according to the disclosure herein.

Further examples, FIG. 2, relate to a network unit 30, for example for a core network of a wireless communication system, comprising at least one apparatus 300 according to the disclosure.

Further examples, FIG. 2, relate to a communication system 1000, for example wireless communication system, comprising at least one of the following elements: a) apparatus 100 according to the disclosure, or b) device 10, for example terminal device, according to the disclosure, or c) apparatus 200 according to the disclosure, or d) unit 20 according to the disclosure, or e) apparatus 300 according to the disclosure, or f) network unit 30 according to the disclosure.

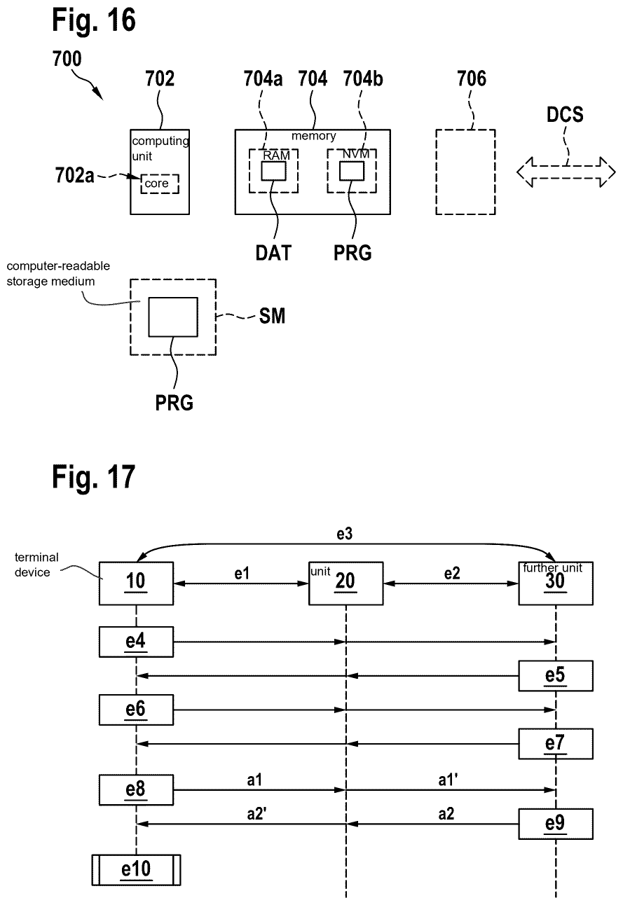

Some examples, FIG. 16, relate to an apparatus 700 for performing the method according to the disclosure. For example, at least some of the apparatuses 100, 200, 300 mentioned above, e.g., with reference to FIG. 2, may have a configuration similar or identical to the configuration as described below as an example with reference to the apparatus 700 according to FIG. 16.

For example, the apparatus 700 comprises a computing unit (“computer”) 702 comprising at least one computing core 702a, and/or a memory unit 704, assigned to the computing unit 702, for at least temporarily storing at least one of the following elements: a) data DAT, b) computer program PRG, for example for performing the method according to the disclosure.

For example, the data DAT characterize at least one of the following elements: a) information I-1 and/or I-2 and/or I-3 and/or I-4 and/or I-5 and/or I-6 and/or other information, or b) public keys, or c) private keys, or d) certificates, or e) information for at least one challenge-response process.

For example, the memory unit 704 has a volatile memory (e.g., random access memory (RAM)) 704a, and/or a non-volatile (NVM) memory (e.g., flash EEPROM) 704b, or a combination thereof or with other types of memory not explicitly mentioned.

Some examples relate to a computer-readable storage medium SM comprising commands, e.g., in the form of at least one computer program PRG, that, when executed by a computer 702, cause said computer to perform the method according to the disclosure.

Some examples relate to a computer program PRG comprising commands that, when the program PRG is executed by a computer 702, cause said computer to perform the method according to the disclosure.

Some examples relate to a data carrier signal DCS that transmits and/or characterizes the computer program PRG according to the disclosure.

Further exemplary aspects and examples are described below and can each be combined individually or in any combination with one another with at least one of the examples described above by way of example.

In some examples, the principle according to the disclosure can be used to replace or supplement any existing authentication processes, such as in 3GPP NR (“5G”), e.g., 5G-AKA (see, for example, 3GPP TS 33.501), for example with regard to a use for subnets 1010.

Some conventional authentication processes assume, for example, that asymmetric cryptographic keys are distributed to a user equipment (UE) and a 5G core (5GC). In some conventional approaches, the keys are stored on a tamper-proof universal integrated circuit card (e.g., UICC), which contains, for example, a Universal Subscriber Identity Module (USIM). This is commonly referred to as a SIM card.

In some conventional approaches, e.g., after a UE first accesses the 5G system, authentication is performed via the USIM. The goal is to achieve mutual authentication of the UE and the 5GC. This phase is called primary authentication. Each USIM corresponds to a subscriber identity, which is specified by a systematic ID called Subscription Permanent Identifier (SUPI); the SUPI does not change. In order to prevent the tracking of terminal devices, the SUPI is not transmitted in plain text over the network during authentication. Instead, an encrypted version of the SUPI, the so-called Subscriber Concealed Identifier (SUCI), is used, which is encrypted with a public key provided by the network.

For other conventional approaches, e.g., in private (e.g., campus) networks, other means of primary authentication, such as EAP-TLS, can also be used.

In some examples, the principle according to the disclosure can be used for communication systems in which the concept of subnetworking, i.e., the use of subnets, is provided, as is provided, for example, for 6G-based systems. In some examples, subnets can be considered, e.g., as a comparatively lightweight version of campus networks and, for example, make local communication possible in an immediate spatial environment, e.g., with a limited number of devices (e.g., up to a few hundred).

In some examples, FIG. 2, the principle according to the disclosure can be used to make it possible to authenticate devices 10, 20 within a subnet 1010, e.g., to simplify such authentication. For example, the principle according to the disclosure can make it possible to mutually authenticate a device 10 connected to a subnet 1010 (e.g., also referred to as a subnet element SNE), and a core network, e.g., a 6G core (6GC). In some examples, the principle according to the disclosure makes it possible to authenticate an SNE 10 to a subnet 1010 and, for example, to verify the trustworthiness of the subnet 1010, thereby achieving, in some examples, mutual authentication between the SNE 10 and the subnet 1010, for example. In order to maintain independence from an operator network, the authentication of the SNE 10 within the subnet 1010 in some examples is possible even without an active connection of the subnet to an operator network.

In some examples, the principle according to the disclosure can be used to authenticate devices in a subnet 1010 in both a static and a dynamic context. In a static context, for example, the devices 10, 20 in a subnet 1010 are fixed and known; in a dynamic context, for example, the devices 10, 20 can enter and leave the subnet 1010 at unknown times.

In some examples, it is proposed to use one or more certificates 10-CERT, 20-CERT (FIG. 2) or aspects of asymmetric cryptography in order, for example, to establish a trust relationship between an operator network and the device 10 and a trust relationship between the device 10 and the subnet 1010.

In some examples, devices 10 can, for example, authenticate themselves to an operator network in two ways:
1) Via a Uu connection: Without the involvement of a subnet 1010, the terminal device 10 registers itself with an operator network, e.g., using conventional, e.g., 3GPP, authentication processes.
2) If the device 10 is connected to a subnet 1010 that, for example, has an active uplink to an operator network. In this case, for example, an authentication protocol can be forwarded transparently via the subnet 1010.

In some examples, FIG. 2, e.g., after successful authentication of the device 10 and the network 1000, the device 10 generates key material or a certificate request, see, for example, also block 460 ff. according to FIG. 9, which is signed, for example, by an authority in the operator network using a known certification authority (CA). For example, a corresponding certificate is generated within the core network, e.g., by signing the public key (“PUB KEY”) together with an (optionally obfuscated) identification. The resulting certificate 10-CERT is then sent back to the device 10, for example. This certificate 10-CERT is, for example, proof that the device 10 has successfully authenticated itself to the core network. In some examples, further information in the certificate 10-CERT may, for example, specify the time of the last authentication and other details. In the case of X.509 certificates, for example, such meta information can be included in the certificate 10-CERT via extension fields.

In some examples, a device 10, e.g., when it is to authenticate itself to a subnet 1010 that does not currently have an uplink connection, may present a previously obtained certificate, e.g., from a local administrative unit of the subnet 1010 (e.g., a subnetwork controller (SNC), 20). In some examples, the subnet 1010 can verify whether:
1) The device 10 has successfully authenticated itself to an operator network. It can identify the operator network, for example, on the basis of the signature in the certificate 10-CERT. For example, the subnet 1010 can trust the CA of the operator network so that this process is legitimate.
2) The subnet 1010 can verify whether the device 10 actually possesses a private key for the certificate 10-CERT, e.g., by carrying out a challenge-response process using the presented certificate, see, for example, also blocks 531, 532 according to FIG. 13. In this way, man-in-the-middle attacks (e.g., by replaying previously captured certificates of other devices) can, for example, be mitigated or prevented in some examples.

In some examples, the subnetwork controller 20, e.g., also, has a certificate 20-CERT, which is, for example, presented to the device 10 during authentication and then verified by said device using a challenge-response process, see, for example, blocks 410, 412, 414 according to FIG. 4. For example, this process makes a certain mutual authentication of the device 10 and the subnet 1010 possible.

For example, the device 10 may verify the following, e.g., depending on the use case: 1) Depending on the CA that signed the certificate of the subnet 1010 or of the SNC 20, the device 10 can assume a different degree of trustworthiness. 2) Depending on the attributes contained in the certificate of the subnet 1010 or of the SNC 20, different purposes of the subnet 1010 can be distinguished (e.g., mission-critical use cases, best-effort use cases, etc.).

Since the certificate in some examples can be verified offline, e.g., without direct involvement of the operator network, this makes it possible, for example, to trust a device 10 without having to contact a unit of the operator network.

In some examples, the acceptance of the presented certificate 10-CERT can be controlled by the subnet 1010, e.g., in order to limit misuse of the proposed concept: For example, if the certificate 10-CERT is too old (i.e., for example, too much time has passed since the last successful authentication of the device 10 to the core network), the authentication request can be rejected. The same can happen, for example, if the certificate 10-CERT contains additional information (e.g., untrusted provider).

Depending on the use case, in some examples, it may be desirable or undesirable for the subnet 1010 to be able to track the device 10 on the basis of the presented certificate 10-CERT. For highly critical devices in technical networks (e.g., in networks in a motor vehicle area), tracking a device 10 may, for example, not be a problem, since the device 10 is known in any case. In this case, for example, specifying a permanent identifier in the certificate 10-CERT can make it possible to create a whitelist for devices that are allowed onto the subnet 1010, e.g., regardless of their last authentication date to the operator network. In public scenarios (e.g., in an open subnet in public transport), tracking devices 10 may be undesirable, e.g., due to privacy concerns. Here, according to some examples, providing a pseudorandom or hidden identifier in the certificate 10-CERT may be more advantageous.

In some examples, the principle according to the disclosure can be used to extend a conventional authentication scheme, such as an existing 3GPP authentication scheme, for example, in order to support creating and/or signing of subnet authentication certificates. In some examples, it may be the case that, whenever a device 10 successfully authenticates to a core network, the device 10 generates an asymmetric cryptographic key pair. Examples in this respect are described in more detail below with reference to FIG. 17. Depending on the use case, the device 10 can, for example, insert a permanent plain-text identifier or an encrypted identifier into a certificate attribute. In some examples, identifiers used may be independent of a SUPI so that the SUPI and the certificate identifier cannot be ascertained, e.g., calculated, based on each other. If, for example, an encrypted identifier is used, the identifier can be encrypted using a key known to the communication system (decryption can, for example, be performed by a core function). For example, the core may be able to establish a relationship between the (e.g., encrypted) certificate identifier and the SUPI, since both are known to the core.

FIG. 17 shows schematic aspects of some examples, which are described in more detail below. The blocks 10, 20, 30 according to FIG. 17 correspond to the blocks 10, 20, 30 according to FIG. 2. Element e1 symbolizes an optional data connection between the device 10 and the SNC 20, and element e2 symbolizes an optional data connection between the SNC 20 and the network unit or a network core, e.g., 6G core, 30, sometimes also referred to as “core” for short below according to some examples.

Element e4 according to FIG. 17 symbolizes an optional conventional, e.g., 5G-AKA, handshake, and element e5 symbolizes a corresponding 5G-AKA handshake response.

In some examples, the device 10 requests a public key for encrypting the identifier, from the network, see element e6 and element e7 for the response thereto, creates the encrypted identifier therewith, and generates the cryptographic key pair KP-ASYM (see also FIG. 2) on the basis of this identifier as an attribute, see element e8 according to FIG. 17. For example, encrypted identifiers are generated in such a way that they change between subsequent authentication attempts, so that, for example, permanent tracking of the identifier is not possible.

The device 10 then generates a certificate signing request from the public key 10-PUB-KEY (optionally with obfuscated identification, see above), see also element e8. The signing request is transmitted to the communication system, see arrows a1, a1′. A core function, e.g., represented by the network unit 30, signs the request a1, a1′ with an operator-specific CA certificate, see element e9, and sends the signed user certificate back to the device 10, see arrows a2, a2′. In some examples, the core function 30 can, for example, enforce policies regarding additional attributes and expiration dates on the basis of the device identity.

During the phase described above as an example, which can also be described as certificate acquisition, the device 10 can be connected, e.g., as a (not yet authenticated) device 10, to the core 30 via a conventional Uu connection e3. In the case of a Uu connection, communication with the core, for example, takes place directly. If the device 10 is an SNE, the communication is routed, for example, via the already authenticated subnet 1010 (see the SNC 20 according to FIG. 17), which acts, for example, as a transparent gateway, see also arrows e1, e2. In this case, it may be the case that the subnet allows the authentication traffic to the core.

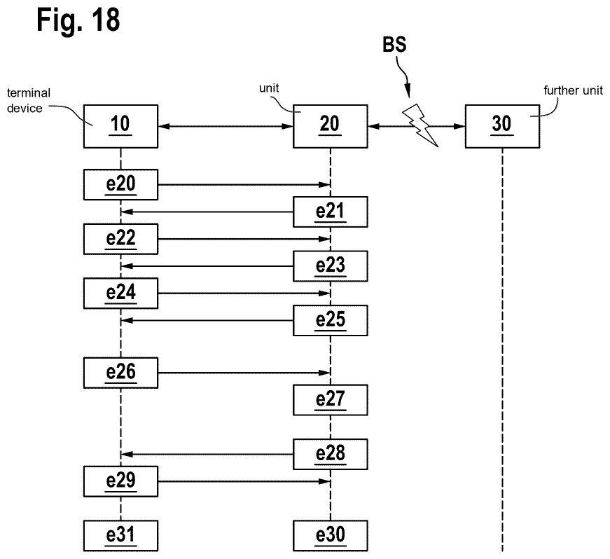

In some examples, e.g., when a device attempts to authenticate itself on a subnet 1010, the subnet 1010 signals its current authentication capabilities in a non-exclusive manner, for example:
1) If the subnet 1010 supports authentication via the operator network, the authentication process can be carried out, for example, as if the subnet 1010 is a transparent proxy or a base station (e.g., gNB) via 5G-AKA or similar. The subnet 1010 may indicate that this authentication option is only available if an uplink connection e2 to an operator network exists.
2) If the subnet 1010 supports certificate-based authentication according to aspects of the disclosure, the device 10 can present a previously acquired authentication certificate to the subnet 1010, see below with reference to FIG. 18.

In some examples, a certificate-based approach can be used according to some aspects of the disclosure to make temporary access of the device 10 to the subnet 1010 possible, e.g., in the event of an uplink failure. In some examples, for example, a conventional procedure, e.g., of the 5G-AKA type, see elements e4, e5 according to FIG. 17, may take precedence over a certificate-based approach according to the disclosure.

In some examples, a subnet 1010 may restrict access by devices 10 that, for example, only want to authenticate themselves via a certificate when the uplink e3 is available, so that the data traffic of such devices 10, e.g., to the subnet 1010 itself, can be restricted (i.e., only local communication). In some examples, e.g., for enforcing such policies, the subnet 1010 may track how a device 10 has authenticated itself. For example, when the uplink e3 has been restored, the subnet 1010 may, for example, request the device 10 to authenticate itself using a specifiable process, such as 5G-AKA, e.g., if the authentication was previously carried out, for example only, by the exchange of certificates. In further examples, the device 10 may query the subnet 1010, e.g., for current authentication capabilities (see, for example, also block 420 of FIG. 5), e.g., in order to authenticate itself via 5G-AKA after the connection has been restored.

In further examples, the subnet 1010 can trust a signing CA of the issuing operator network, e.g., so that the subnet 1010 can allow a device 10 on the basis of a presented certificate 10-CERT. For this purpose, in some examples, a list of trusted CA certificates can be provided, for example, installed securely in a local administration of the subnet 1010.

In further examples, FIG. 17, the SNC 20 also has a certificate 20-CERT (FIG. 2), which can be used, for example, to authenticate the subnet 1010 to the device 10. This certificate 20-CERT of the SNC 20 can, e.g., also, be signed by a specific CA. Since the ownership of the subnet 1010 may depend on a use case in some examples, extension fields in the certificate 20-CERT can, for example, be used, e.g., to specify different purposes of the subnet 1010 that may be processed, e.g., by the device 10: For mission-critical use cases (e.g., offloading of critical vehicle functions of motor vehicles), the subnet 1010 can be marked as such, and the signing CA of the certificate 20-CERT can, e.g., be given a comparatively high degree of trust, e.g., in comparison to situations in which the subnet 1010 is used, e.g., only, for providing best-effort services. For example, mutual authentication can ensure that the subnet 1010 can be trusted when providing the advertised services, e.g., since a trusted CA vouches for the subnet 1010. In some examples, obtaining and/or installing a list of trusted CA certificates or signed SNC certificates can be integrated into an official product certification process, for example, but is outside the scope of this disclosure.

Further aspects and examples regarding the acquisition of a subnet authentication certificate with encrypted ID are described below with reference to FIG. 17.

Aspect 1: The authentication of the device, e.g., UE, 10 to the core network 30 is carried out, for example, according to the 3GPP specifications, see blocks e1, e2.

In a first option a), this authentication is carried out, for example, when the device 10 is connected to a subnet 1010. The subnet acts, for example, as a transparent gateway, e.g., in such a way that the device 10 uses the connection e2 provided by the subnet, to communicate with the core 30. In this case, the trust of the device 10 in the subnet 1010 or in the SNC 20 can be established, for example, by validating a certificate 20-CERT (FIG. 2) of the SNC 20 in the device 10, as shown, for example, in FIG. 18, see elements e20, e21, e22, e23, and described in detail below.

In a second option b), the device 10 has, for example, no association with a subnet 1010, which means that this step (authentication to the core network) and, for example, the following steps are carried out via a Uu connection e3 directly to the core 30.

Aspect 2: The device 10 (FIG. 17) requests a key from the network or the network unit 30, which key is optionally used, for example, to encrypt a subsequently generated identification or identifier of the device 10, see blocks e6, e7, e8. In some examples, the encryption of the identification is used to hide the identity of the device 10 from third parties (e.g., from the subnet 1010).

Aspect 3: The device 10 generates a cryptographic key pair KP-ASYM (FIG. 2), see also element e8 according to FIG. 17. The certificate 10-CERT (FIG. 2), which belongs to a public key of the key pair KP-ASYM, contains a device ID. The device ID may, for example, be encrypted or unencrypted using the key obtained according to aspect 2. The device 10 can use these data, for example, to generate a certificate signing request, see element e8, and sends it to the core 30, see arrows a1, a1′, where it is signed, for example, by the CA of the core 30, see element E9. The certificate signed in this way is sent back to the device 10, see arrows a2, a2′.

Further aspects and examples regarding authentication with the subnet, e.g., without uplink e3 (FIG. 17) to an operator network, are described below with reference to FIG. 18. The scheme shown in FIG. 18 is applicable, for example, when the subnet 1010 has no connection to the core network. For example, the device 10 wants to authenticate itself to the subnet 1010 and can do so using the previously obtained certificates (see FIG. 17), for example.

Aspect 1: The device 10 requests the certificate 20-CERT of the SNC 20, see element e20, and the SNC 20 sends the certificate 20-CERT to the device 10, see element e21. For example, the certificate 20-CERT contains information about the purpose of the subnet, and the signing CA associated with the certificate 20-CERT specifies a degree of trustworthiness for the SNC 20.

Aspect 2: The device 10 performs a challenge process, see elements e22, e23, in order to validate that the SNC 20 actually possesses the private key for the presented certificate 20-CERT. After the query, the device 10 can verify the signature of the received certificate and compare it with its trust store (not shown). Depending on the use case, which is specified, for example, via the options in the certificate 20-CERT and the degree of trust by the verified certificate chain, the device 10 can decide to restrict the services advertised to or used by the subnet.

Aspect 3: The device 10 inquires about the authentication methods supported by the SNC 20, see elements e24, e25. For example, the SNC 20 can report that, for example, due to an uplink failure (see the lightning symbol BS), currently, for example only, certificate-based authentication is supported, but not authentication by the core 30, for example.

Aspect 4: The device 10 transmits a certificate that it has previously obtained, for example based on the procedure according to FIG. 17, see element e26 of FIG. 18. The SNC 20 verifies the signature of the certificate and ensures that the signing CA is trustworthy, see element e27. The SNC, see element e28, then sends a request to the device 10, e.g., in order to ensure that the device 10 has the corresponding private key for the certificate(s) presented. For example, a conventional, for example standardized, process, e.g., according to an industry standard, can be used to ensure this.

Aspect 5: After completing the query, the SNC 20 can allow or reject the device 10, see element e30, for example based on the response e29 of the device 10. In some examples, the SNC 20 may apply an access profile that restricts the access of the device 10. The decision on the access profile may depend, for example, on extension fields in the certificate of the device 10 and/or on other information. Element e31 according to FIG. 18 symbolizes a use of the subnet by the device 10, for example based on the optionally present access profile.

In some examples, it may be the case that the device 10 must first authenticate itself to the SNC 20, for example. In this case, an order of the elements according to FIG. 18 can be as follows: e24, e25, e26, e27, e28, e29, e20, e21, e22, e23.

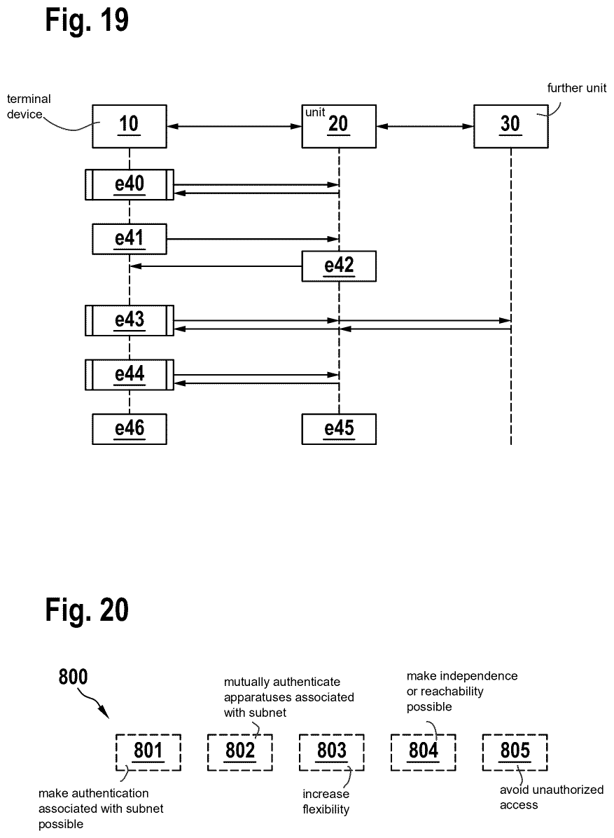

Aspects of authentication in a subnet with a functioning operator network uplink (data connection, e.g., between the SNC 20 and the core 30) according to some examples are described below with reference to FIG. 19. This procedure according to FIG. 19 is therefore applicable, for example, when the subnet offers multiple options for authentication (via operator network, for example in a conventional manner, and/or according to the principle of the disclosure).

Aspect 1: Elements e40, e41, e4, e.g., analogous to the elements e20, e21, e22, e23 according to FIG. 18: The certificate of the subnetwork controller 20 is obtained, challenged, and verified.

Aspect 2: Elements e41, e42, e.g., analogous to FIG. 18, elements e24, e25: The device 10 requests authentication options supported by the subnetwork controller 20. Since an active uplink to the core 30 exists in the example according to FIG. 19, the subnetwork controller 20 signals in element e42, for example, that it supports both direct (e.g., 5G/6G) authentication (e.g., as shown in FIG. 17) and, e.g., internal (without the core 30), certificate-based authentication according to the disclosure.

Aspect 3: The device 10 decides, for example, to authenticate with the core 30, see element e43, e.g., using the subnet as connection provider (see, for example, also FIG. 17, elements e1, e2). The signaling for this is carried out, for example, as already described with reference to FIG. 17.

Aspect 4: Optionally, see element e44, the device 10 can use a (e.g., previously acquired) certificate for authentication to the subnet (see procedure according to FIG. 18). For example, the subnetwork controller 20 can track that the device 10 has successfully authenticated itself to the core 30 and to the subnet. Therefore, the SNC 20 can, for example, assign a different access profile to the device 10, see element e45, than in FIG. 18, where authentication through the core 30 was not possible due to the disruption BS of the data connection to the core 30. Element e46 symbolizes a use of the subnet by the device 10, for example based on the access profile.

Some examples, FIG. 20, relate to a use 800 of the method according to the disclosure, and/or of the apparatus 100, 200, 300 according to the disclosure, and/or of the device 10, for example terminal device, according to the disclosure, and/or of the unit 20, for example control unit (for example, SNC), for a subnet 1010 of a wireless communication system 1000 according to the disclosure, and/or of the network unit 30, for example for a core network of a wireless communication system 1000, according to the disclosure, and/or of the communication system 1000 according to the disclosure, and/or of the computer-readable storage medium SM according to the disclosure, and/or of the computer program PRG according to the disclosure, and/or of the data carrier signal DCS according to the disclosure for at least one of the following elements: a) making 801 authentication associated with the subnet 1010 possible, for example without a connection to a network of an operator, for example core network, or b) mutually authenticating 802 apparatuses associated with the subnet 1010, or c) increasing 803 flexibility, for example for operation of the subnet, or d) making 804 independence from an operator network or reachability of the operator network possible, or c) avoiding 805 unauthorized access to the subnet 1010.

What is claimed is:

1. A method for a device, for a subnet of a wireless communication system, comprising the following steps:
sending a request to transmit first information to a control unit for the subnet, wherein the first information makes it possible to verify an authenticity of at least one unit associated with the subnet;
receiving a response including at least the first information.

2. The method according to claim 1, wherein the response further includes configuration information associated with the subnet.

3. The method according to claim 1, further comprising:
sending second information to the unit, for verifying an authenticity of the unit;
receiving third information from the unit, wherein the third information has been generated by the unit based at least in part on the second information; and
verifying the third information based at least on the first information.

4. The method according to claim 1, wherein the response includes a certificate associated with the unit, the certiface including a public key associated with the unit.

5. The method according to claim 1, further comprising:
sending a request regarding options for authentication by the unit, to the unit;
receiving a response including information regarding the options for authentication by the unit.

6. The method according to claim 1, further comprising:
sending fourth information, which makes it possible to verify an authenticity of the device to the unit;
receiving fifth information from the unit for verifying an authenticity of the device.

7. The method according to claim 6, comprising:
generating sixth information based at least on the fifth information and a private key associated with the device;
sending the sixth information to the unit.

8. The method according to claim 1, further comprising:
using the subnet based on configuration information for the subnet; and,
exchanging information using the subnet.

9. The method according to claim 1, further comprising:
requesting key information for encrypting information to be sent to at least one other unit;
receiving the key information.

10. The method according to claim 1, further comprising:
generating an asymmetric key pair;
encrypting an identification associated with a public key of the asymmetric key pair using a public key of a core network;
sending a certificate signing request to sign the public key together with the encrypted identification, to at least one other unit;
receiving a response, in the form of a certificate, to the certificate signing request; and,
using at least parts of the response for authentication, for the subnet, when a network unit is not reachable at least temporarily.

11. An apparatus configured to:
send a request to transmit first information to a control unit for a subnet of a wireless network, wherein the first information makes it possible to verify an authenticity of at least one unit associated with the subnet;
receive a response including at least the first information.

12. A method for a control unit for a subnet of a wireless communication system, comprising:
receiving a request to transmit first information from a terminal device, for the subnet, wherein the first information makes it possible to verify an authenticity of at least one unit associated with the subnet;
sending a response including at least the first information to the terminal device, wherein the response additionally includes configuration information associated with the subnet, wherein the response includes a certificate associated with the control unit, the certificate including a public key associated with the control unit.

13. The method according to claim 12, comprising:
receiving second information from the terminal device for verifying an authenticity of the control unit;
forming third information based at least in part on the second information;
sending the third information to the terminal device.

14. The method according to claim 12, further comprising:
receiving a request regarding options for authentication by the unit;
sending a response including information regarding the options for authentication by the control unit, to the terminal device.

15. The method according to claim 12, further comprising:
receiving fourth information, which makes it possible to verify an authenticity of the terminal device;
verifying the authenticity of the terminal device based at least on the fourth information;
performing a challenge-response process with respect to the terminal device;
allowing the terminal device onto the subnet based on a result of the challenge-response process.

16. An apparatus configured to:
receive a request to transmit first information from a terminal device, for a subnet of a wireless communication system, wherein the first information makes it possible to verify an authenticity of at least one unit associated with the subnet;
send a response including at least the first information to the terminal device, wherein the response additionally includes configuration information associated with the subnet, wherein the response includes a certificate associated with the control unit, the certificate including a public key associated with the control unit.

17. A method for a core network of a wireless communication system, comprising the following steps:
receiving a request directly from a device or from the device via at least one further unit, for a subnet of the wireless communication system, to request key information for encrypting information to be sent using the device to at least one other unit;
sending the key information directly to the device or to the device via a control unit for the subnet of the wireless communication system.

18. The method according to claim 17, further comprising:
receiving a request, from the device, to sign a public key of the device;
signing at least part of information associated with the request and contained in the request, thereby obtaining signed information;
sending the signed information to the device, directly or via a control unit, for a subnet of the wireless communication system.

19. An apparatus configured to:
receive a request directly from a device or from the device via at least one further unit, for a subnet of the wireless communication system, to request key information for encrypting information to be sent using the device to at least one other unit;
send the key information directly to the device or to the device via a control unit for the subnet of the wireless communication system.

20. A communication system, comprising at least one of the following elements:
a) an apparatus configured to
send a request to transmit first information to a control unit for a subnet of a wireless network, wherein the first information makes it possible to verify an authenticity of at least one unit associated with the subnet, and
receive a response including at least the first information; or
b) an apparatus configured to:
receive a request to transmit first information from a terminal device, for a subnet of a wireless communication system, wherein the first information makes it possible to verify an authenticity of at least one unit associated with the subnet,
send a response including at least the first information to the terminal device, wherein the response additionally includes configuration information associated with the subnet, wherein the response includes a certificate associated with the control unit, the certificate including a public key associated with the control unit; or
c) an apparatus configured to:
receive a request directly from a device or from the device via at least one further unit, for a subnet of the wireless communication system, to request key information for encrypting information to be sent using the device to at least one other unit,
send the key information directly to the device or to the device via a control unit for the subnet of the wireless communication system.
